(19) United States
(12) Patent Application Publication
(10) Pub. No.: US 2012/0066156 A1
(43) Pub. Date: Mar. 15, 2012

(54) Systems and methods for dispensing reusable shopping bags

(76) Inventors: Margaret Pryor, Charlotte, NC (US); Taylor Carrie, Noblesville, IN (US)

(21) Appl. No.: 13/199,900

(22) Filed: Sep. 13, 2011

Related U.S. Application Data
(60) Provisional application No. 61/382,555, filed on Sep. 14, 2010.

(51) Int. Cl. G06Q 90/00; A47F 9/04

(52) U.S. Cl. 705/500; 186/66

(57) ABSTRACT

A system for dispensing and collecting reusable bags at a store includes a purchase system, including a supply of bags, and a return system, disposed in a store, for receiving returned bags for reuse. The purchase system includes a store checkout stand, a store scanner, and at least one of a cash register, a store customer service counter, and/or a kiosk located near the entrance/exit of the store. The return system includes the store customer service counter, cash register, and/or kiosk. The kiosk includes a display screen, a scanner/RFID reader, a credit card reader, a bag dispenser, a return chute, and a voucher/refund dispenser. Various methods of use of such a system for dispensing and collecting reusable bags are disclosed.

### CROSS-REFERENCE TO RELATED APPLICATIONS

This application claims the benefit of provisional patent application Ser. No. 61/382,555, filed 2010 Sep. 14.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE PRESENT INVENTION

1. Field of the Present Invention

The present invention relates generally to systems and methods for dispensing and recycling reusable shopping bags.

2. Background

The busy lifestyle of the targeted customer often makes it a challenge to make use of reusable bags when shopping. Many customers would prefer to use reusable bags for purchases. However, they may find themselves without a reusable bag either from hastily running to the store or from simply forgetting to bring a bag in from the car for reuse. Even when a customer does have a bag in the car, they may not have enough bags to carry out purchases. These behaviors/habits may contribute to the use of retailer-provided paper or plastic bags, and inhibit the amount of products purchased and stunt the last minute ‘impulse buy’ of the customer.

Though the targeted customer may be environmentally conscious, they may find themselves without a convenient, low cost alternative to using retailer-provided paper or plastic bags when they forget to bring their own or don't have enough with them. They may find themselves purchasing new reusable bags. Many customers report having amassed more reusable bags than they need as a result of purchasing new ones when they don't have enough or have forgotten to bring their bags. Still other customers do not own reusable bags because of the cost.

### SUMMARY OF THE PRESENT INVENTION

The present invention pertains to a system for dispensing and collecting reusable bags that is designed to increase the use of reusable bags by providing a cost efficient alternative to using retailer-provided paper or plastic bags, or to purchasing a new reusable bag. The present invention makes reusable bags readily available for customers to rent and return for less cost than conventional reusable bags. The bags will be conveniently located at participating retailers for a competitive price and can be returned at return kiosks for a partial refund of the purchase. The customer will, in essence, rent the bag until returning the product to the kiosk. Customer may have the option to keep the product without a refund as well.

In at least some embodiments, the participants in the present invention's process may include retailers, vendors, and customers. Retailers may be defined as merchants who sell the present invention's product and services or who honor the return receipt of the customers. Vendors may be defined as those who provide the kiosk and product services. Vendors may be independent owners, or larger companies, who have bought the rights to be franchisees or licensees of the present invention's operation. Customers may be persons who purchase the present invention's product or use the kiosk return system for a refund.

In at least some aspects, the present invention's process may complement the busy lives of customers without adding overhead or additional costs to retailers. Those who may benefit from the present invention's process include, but are not limited to, stores, who may be able to reduce cost of discretionary expenses when customers buy reusable bags; retailers, who may be able to respond to societal pressure for providing green alternatives; customers who may have, or may like to utilize, reusable bags but cannot or will not buy a new bag with each visit; and the environment, through the reduction of countless plastic bags by promoting the use of reusable bags.

Broadly defined, the present invention according to one aspect is a system for dispensing and collecting reusable bags at a store, including: a purchase system, including a supply of bags; and a return system, disposed in a store, for receiving returned bags for reuse.

In features of this aspect, the purchase system includes a store checkout stand, a store scanner, and at least one of a cash register, a store customer service counter, and/or a kiosk located near the entrance/exit of the store; the return system includes the store customer service counter, cash register, and/or kiosk; and the kiosk includes a display screen, a scanner/RFID reader, a credit card reader, a bag dispenser, a return chute, and a voucher/refund dispenser.

Broadly defined, the present invention according to another aspect is a system for dispensing and collecting reusable bags at a store, substantially as shown and described.

Broadly defined, the present invention according to another aspect is a method of collecting reusable bags at a store, substantially as shown and described.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Further features, embodiments, and advantages of the present invention will become apparent from the following detailed description with reference to the drawings, wherein:

FIG. 1 is a block diagram illustrating the present invention's system in accordance with one or more preferred embodiments of the present invention;

FIG. 2 is a high level flowchart diagram summarizing several main processes carried out by the system of FIG. 1;

FIG. 3 is a flowchart diagram illustrating the operation of the product cycle process;

FIG. 4 is a flowchart diagram illustrating the operation of the customer cycle process;

FIG. 5 is a flowchart diagram illustrating the operation of a first version of the return process;

FIG. 6 is a flowchart diagram illustrating the operation of a second version of the return process; and

FIG. 7 is a flowchart diagram illustrating the operation of a third version of the return process.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, the preferred embodiments of the present invention are next described. The following description of one or more preferred embodiment(s) is merely exemplary in nature and is in no way intended to limit the invention, its application, or uses.

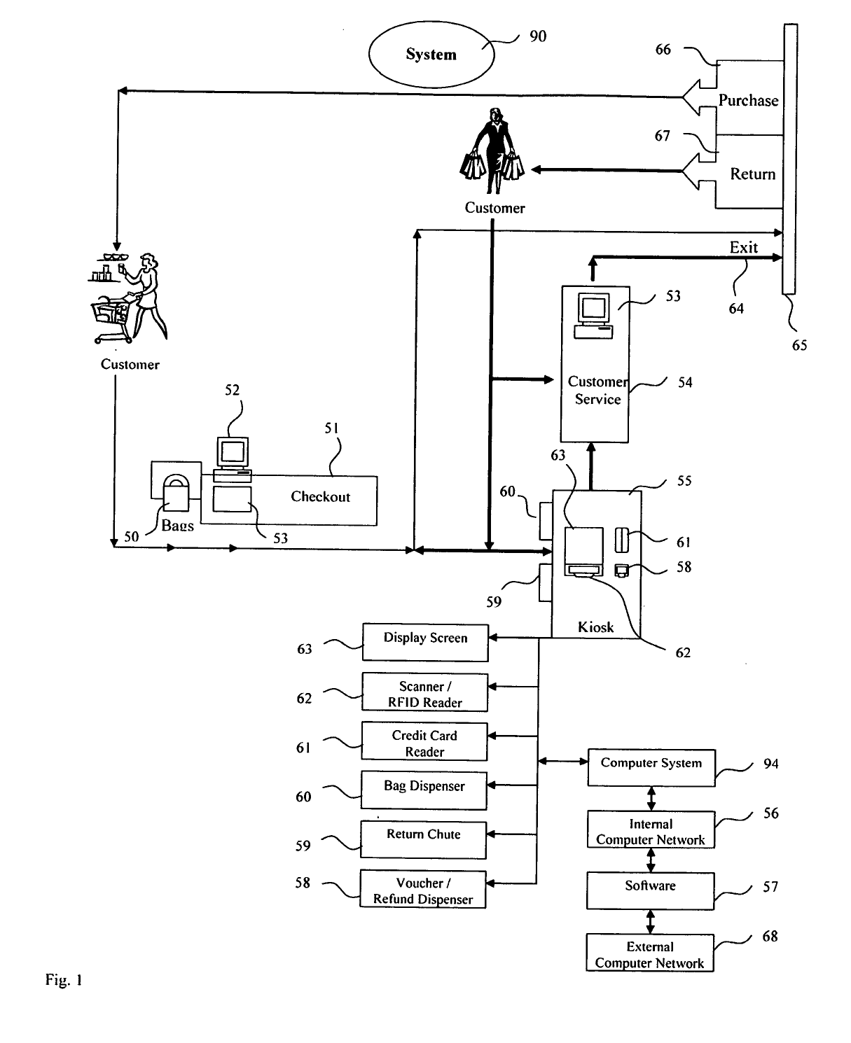

FIG. 1 is a block diagram illustrating a system 90 for dispensing and collecting reusable bags 50 in accordance with one or more preferred embodiments of the present invention. As shown therein, the system 90 includes a purchase system 66, which may involve a large number of reusable bags 50, a store checkout stand 51, a store scanner 53, a cash register 52, and/or a store customer service counter 54, and/or a kiosk 55 located near the entrance/exit 64, 65 of the store. System 90 also includes a return system 67, which may involve a store customer service counter 54, a cash register 53, and/ or a kiosk 55. The kiosk 55 may include a display screen 63, a scanner/RFID reader 62, a credit card reader 61, a bag dispenser 60, a return chute 59, and a voucher/refund dispenser 58. The system 90 and kiosk 55 may include a computer system 94. The computer system 94 includes an internal network 56, and external network 68, and software for implementing a bag borrowing and collecting process 57. Each dispensing machine has an Internet uplink that networks all of the machines together through the Internet, coordinates the user experience via the system website, and allows the system administrator to manage all of its operations at a centralized location.

The bags 50 utilized in the system 90 of the present invention may generally be any type of reusable bag suitable for carrying groceries or the like. In particular, however, each bag 50 is an easily identifiable bag made of a fabric or fabric blend that may separate it from the current trend of using polypropylene bags. The bag may be constructed of a comfortable material which also looks great and is still functional after numerous washings. Additionally, large decorative and functional contrasting double-stitched seams and a logo may be may be incorporated in the design of the bag 92. The construction of such bags may include a dual set of handles to enable the user to carry it over their shoulder or by hand making it easier to carry several bags at once. The bags may be made of a hemp/cotton blend. The bag may be constructed using fabric treated with antimicrobial technology. The bag may be designed to fit over existing bagging equipment at retailers.

In at least one contemplated commercial embodiment, each bag may be constructed to be 15″ in height, 15″ in width and 7 inches deep, with 25 inch loop handles (or with smaller loops for hanging on cart hooks).

Furthermore, in at least one contemplated commercial embodiment, the bags may be made from 5 oz. 55/45 hemp/cotton pre-washed fabric. The materials may also incorporate antimicrobial technologies in the manufacture of the bag.

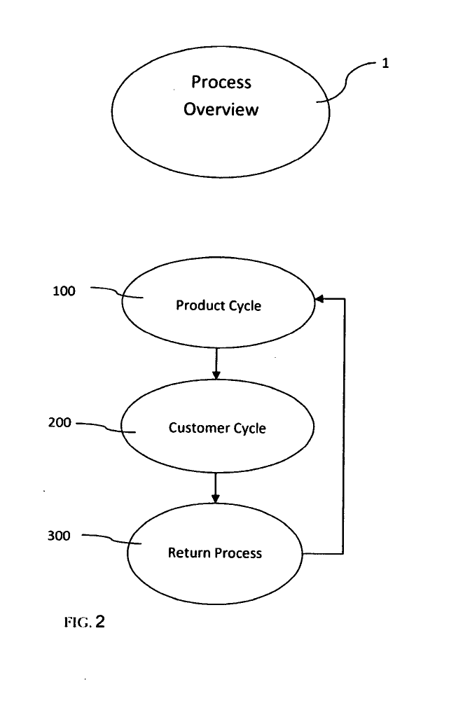

FIG. 2 is a high level flowchart diagram summarizing several main processes carried out by the system of FIG. 1. As shown therein, there are preferably three main processes associated with the process. These may include the product cycle 100, the customer cycle 200 and the return process 300. The details for these processes are described below.

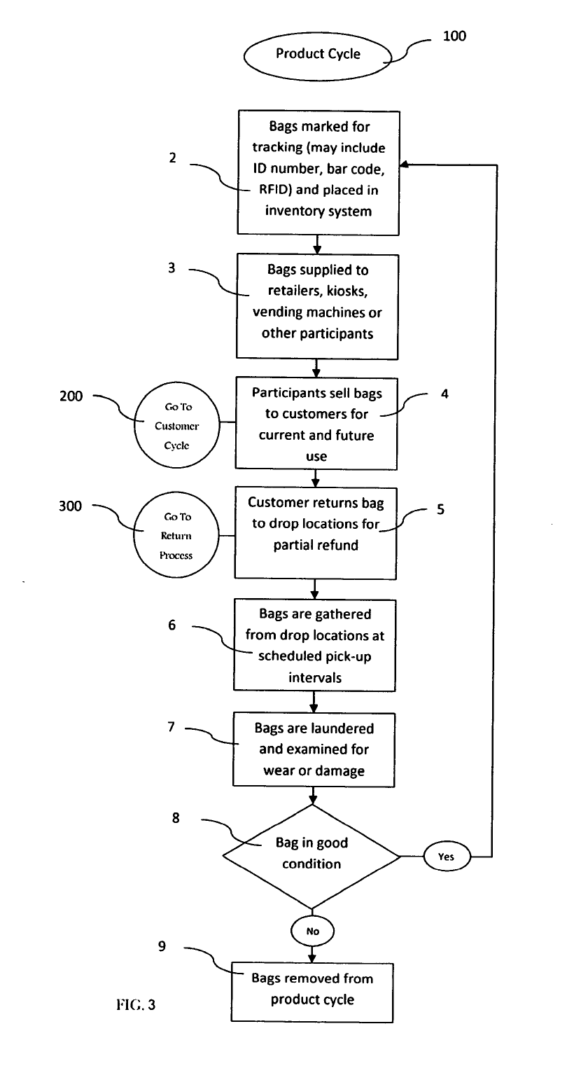

FIG. 3 is a flowchart diagram illustrating the operation of the product cycle process 100. The product cycle 100 may involve a cycle of purchase, use, return/keep, and may utilize an inventory system for tracking the bags 2 in a database or other transaction systems. Bags are supplied to participants 3. A customer may purchase a bag with the option to keep the bag or return the bag for a partial refund, as shown at steps 4, 5. After being returned by the customer, the bags may be stored at the drop off location to await pick up 6. Once picked up, they will be laundered and examined for reintroduction into the product cycle 7. Since the bag may be constructed of natural fibers, it may be laundered and sanitized after each use 7. The condition of the bag is checked for excessive wear or damage 8, and will either be reused in the product cycle or be removed from the product cycle 9. The bags may also incorporate antimicrobial technology in the fabric. Each bag may have tracking identification manufactured or sewn into the fabric 2.

Tracking and identification options for the bag may include, but are not limited to, identification tracking number tags or labels, barcode ID tags or labels, Radio Frequency Identification (RFID) tags or labels, Unique Item Identification (UID) tags or labels, microchip identification, and/or other asset or tracking tags.

An RFID reader is the preferred solution for a reader system because of the following characteristics: may reactivate the anti-theft bit on the tag, can provide return receipts, is relatively reliable in harsh environments, and allows customers to return the bags and get an automated receipt without the help of staff members. Other reader solutions could alternatively be used.

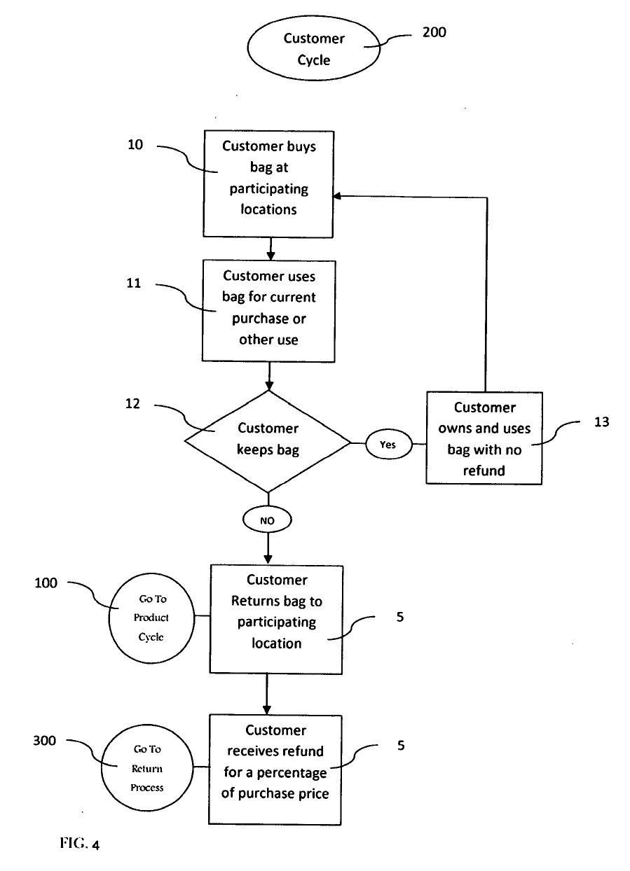

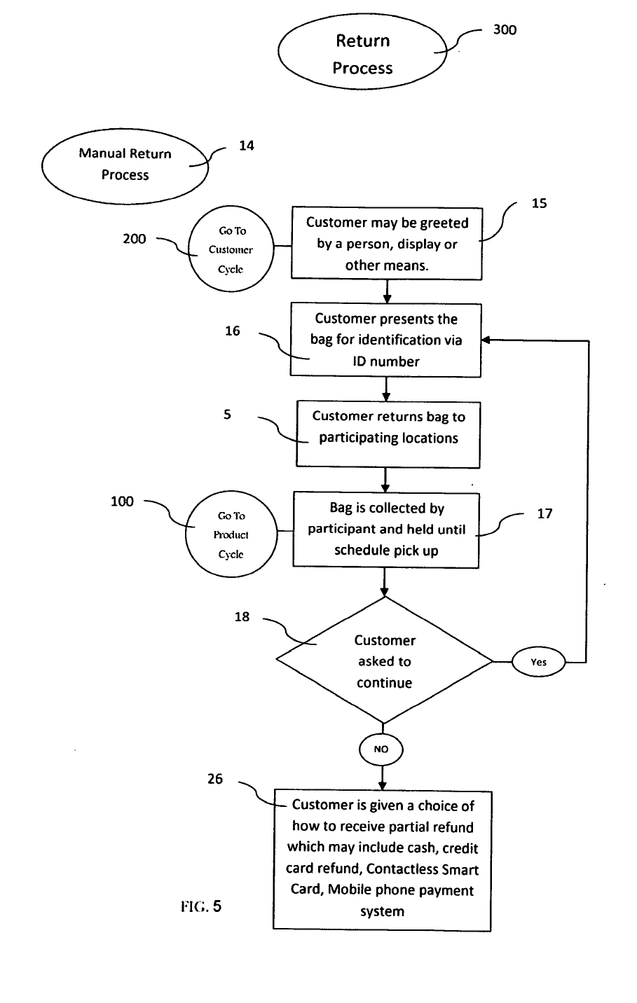

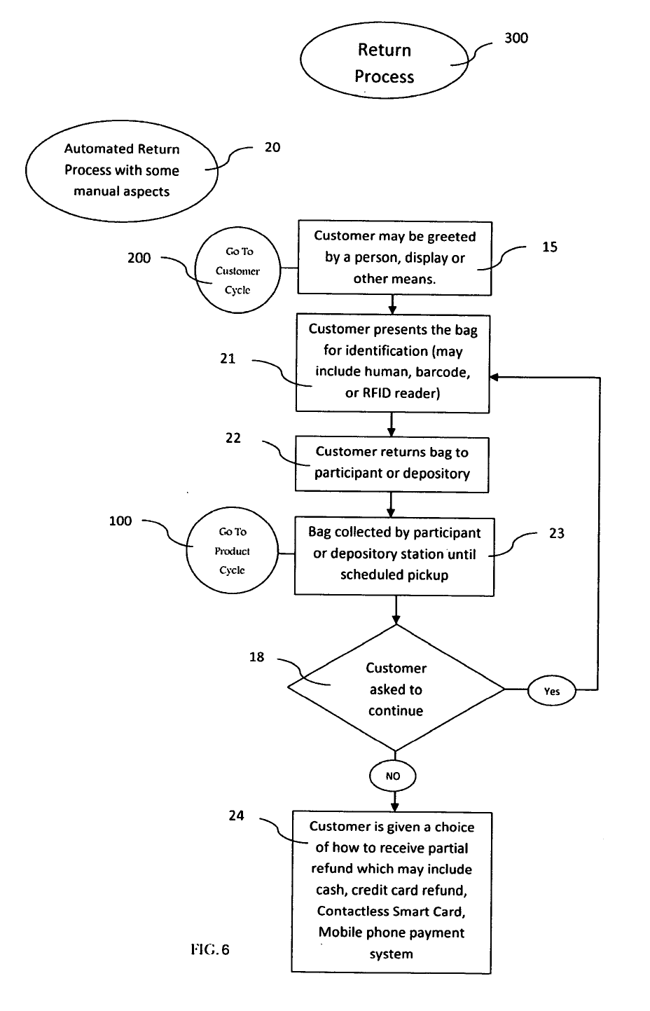

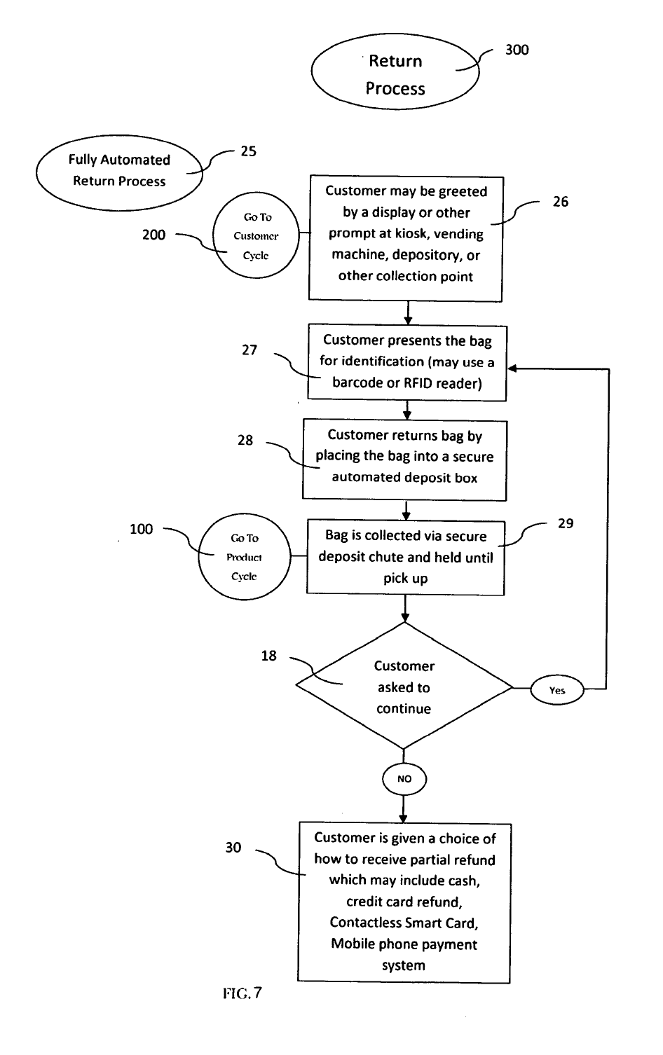

FIG. 4 is a flowchart diagram illustrating the operation of the customer cycle process 200, while FIGS. 5-7 are flowchart diagrams illustrating the operation of three different versions of the return process 300. In particular, the return process may be implemented using a manual 14, semi-manual 20, or fully automatic 25 return process, as shown in FIGS. 5, 6 and 7, respectively. As shown in FIG. 5, the manual return process 14 may involve the customer visiting participating locations and being greeted by a person, display, or other means 15. The customer might present the bag for identification 16, and then return the bag to the participant in exchange for a refund or voucher 5, 26. As shown in FIG. 6, the semi-manual process 20 may be a hybrid of both the manual 14 and automatic 25 return processes. It may use some any combination of the two processes in order to complete the return process 14, 25. As shown in FIG. 7, the fully automated return process 25 may center on a vending-type kiosk. The machines may have the capacity to sell, receive bags and refund the appropriate amount. Some technologies utilized in this process might include a drop slot with an integrated ID reader, a barcode scanner, or a keypad for entering bag numbers 27. The customer can drop the bags into the return chute then get an automated receipt or refund 28, 30.

The machines may have a slot with a barcode, RFID or UID reader integrated in it. The customer can drop the bags into the return chute triggering an automated receipt showing how many and which bags have been returned 28. The Bag Drop Station can be placed at any convenient location to enable customers to return their items anytime. In at least one preferred embodiment, RFID tags are used because they do not require line-of-sight and thus may be easier to use, more durable, or the like relative to barcodes. Most RFID vendors claim that each tag may handle a minimum of 100,000 transactions before the tag may need to be replaced.

The bag's RFID may be tracked by using a database inventory system or similar systems for purchases and refunds. Refund options for the present invention's bag may include, but are not limited to, traditional cash and credit card transactions, voucher transactions, mobile phone or mobile device transactions, contactless smart card transactions, membership card transactions, and the like 30.

With particular reference to FIGS. 3, 4, 6 and 7, the various processes 100, 200, 300 are preferably carried out, using a kiosk, as follows. A commercial entity supplies bags to retailers at step 3. Each retailer sells bag/ Customer purchases bag (with barcode or RFID) 4, 10. The customer uses bag 4, 11 and either keeps bag 12, 13 or returns bag to kiosk 5, 22. The customer scans barcode/RFID on bag 21 and deposits the bag 92 into steel tamper resistant deposit box (kiosk) 28. The customer receives refund receipt to be redeemed for cash at participating stores 19, 24, 30. Bags are then gathered by the commercial entity at scheduled pick up intervals 6, 17, 23, 29, and the bags 92 are laundered and sterilized and are returned to cycle 2, 7, 8.

In a first alternative embodiment, in which some or all portions of the manual version 14 of the return process 300 are utilized, the commercial entity supplies bags to retailers 3. The retailer sells bag/Customer purchases bag (with identification number on bag) 4, 10. The customer uses bag 4, 11 and either keeps the bag 12, 13 or returns the bag to Customer Service counter 5. Customer Service logs ID number or scans barcode 16 and refunds a percentage of the cost of bag to user 19, 24, 30. Customer Service stores returned bags in a bin 17, and the bags are gathered at scheduled pick up intervals 6, 17. Bags are laundered and sterilized and are returned to cycle 2, 7, 8.

In a second alternative embodiment, in which barcodes are utilized, the commercial entity supplies bags to retailers 3 the retailer sells bag/Customer purchases bag (with barcode) 4, 10. The customer uses bag 4, 11 and either keeps the bag 12, 13 or returns the bag to Customer Service counter 5. Customer Service scans barcode 16 and refunds a percentage of the cost of bag to user 19, 24, 30. Customer Service stores returned bags in a bin 17, and the bags are gathered at scheduled pick up intervals 6, 17. The bags are then laundered and sterilized and are returned to cycle 2, 7, 8.

In a third alternative embodiment, in which membership cards are utilized, the commercial entity supplies bags to retailers 3. The retailer sells bag/Customer purchases bag (with barcode or RFID) 4, 10. The customer uses the bag 4, 11 and either keeps the bag 12, 13, or returns the bag to a kiosk 22, 28, where the customer scans the barcode/RFID on bag 16, 21, 27 and deposits the bag into a steel tamper resistant deposit box (kiosk) 22, 29. The customer may scan membership card for cash credit to be used at participating retailers 19, 24, 30. The bags are gathered at scheduled pick up intervals 6, 17, 23. The bags are then laundered and sterilized and are returned to cycle 2, 7, 8

In a fourth alternative embodiment, in which a kiosk is utilized for sales and returns, the commercial entity supplies bags to kiosks at retailers 3. The customer scans credit card to purchase a bag from the kiosk 4, 10. The kiosk dispenses a bag (with barcode or RFID) 26. The customer uses the bag 4, 11, and either customer keeps the bag 12, 13, or the customer returns the bag to a kiosk 22, 28. The customer scans the barcode/RFID on bag 16, 21, 27 utilizing a barcode/RFID reader on the kiosk. The customer deposits bag into a steel tamper resistant deposit box (kiosk) 28 and receives a partial refund via credit applied to credit card account 19, 24, 30. The bags are gathered at scheduled pick up intervals 6, 17, 23. The bags are then laundered and sterilized and are returned to cycle 2, 7, 8.

In a fifth alternative embodiment, in which a kiosk is utilized for sales and returns involving RFID/Mobile Phone Link, the commercial entity supplies bags to kiosks at retailers 3. The customer uses a mobile phone/RFID link to purchase a bag from the kiosk 4, 10. The kiosk dispenses a bag (with RFID) 26. The customer uses the bag 4, 11 and either keeps the bag 12, 13, or returns the bag to a kiosk 22, 28. The customer scans the RFID on the bag 16, 21, 27 utilizing an RFID reader on the kiosk. The customer deposits bag into steel tamper resistant deposit box (kiosk) 28 and receives a partial refund to an account via mobile phone/RFID link 19, 24, 30. The bags are gathered at scheduled pick up intervals 6, 17, 23. The bags are then laundered and sterilized and are returned to cycle 2, 7, 8.

In a sixth alternative embodiment, in which a kiosk is utilized for sales and returns involving a Contactless Smart Card, the commercial entity supplies bags to kiosks at retailers 3. The customer uses a Contactless Smart Card to purchase a bag from the kiosk 4, 10. The kiosk dispenses a bag (with RFID) 26. The customer uses the bag 4, 11 and either keeps the bag 12, 13, or the customer returns the bag to the kiosk 22, 28. The customer scans the RFID on the bag 16, 21, 27 utilizing an RFID reader on the kiosk. The customer deposits the bag into a steel tamper resistant deposit box (kiosk) 28 and receives partial refund to an account via Contactless Smart Card 19, 24, 30. The bags are gathered at scheduled pick up intervals 6, 17, 23. The bags are laundered and sterilized and are returned to cycle 2, 7,8

The target customer may include any individual who currently or prospectively shops at retail stores. This includes but is not limited to customers who regularly purchase and use reusable bags but find themselves without a bag; customers who have some reusable bags, but not enough for the entire purchase; customers who would like to use reusable bags, but do not want the cost of purchasing bags; and customers who normally would not purchase reusable bags, but are interested in the present invention's experience.

The bags may be located near checkout stands, throughout a store, or at vending and kiosk sites for the customer's convenience. The customer may purchase the bag 10, and then have the option of keeping the bag for the purchase price 12, or returning the bag to participating locations for a refund of a portion of the purchase price 5. Purchasing options for the bag may include traditional cash transactions, voucher transactions, mobile phone or mobile device transaction, contactless smart card transactions, membership card transactions, and the like.

In other features, additional sizes of bags may be offered to accommodate larger products such as clothing, shoes, and home goods. Other types of bags may include insulated bags, wine bottle bags, produce bags, and other specialty bags. Additionally, retailers may want to sponsor these bags for their specific stores by including their logo beside the present invention's logos.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is provisionally claimed is:

1. A system for dispensing and collecting reusable bags at a store, comprising:
a purchase system, including a supply of bags; and
a return system, disposed in a store, for receiving returned bags for reuse.

2. The system of claim 1, wherein the purchase system includes a store checkout stand, a store scanner, and at least one of a cash register, a store customer service counter, and/or a kiosk located near the entrance/exit of the store.

3. The system of claim 1, wherein the return system includes the store customer service counter, cash register, and/or kiosk.

4. The system of claim 2 or 3, wherein the kiosk includes a display screen, a scanner/RFID reader, a credit card reader, a bag dispenser, a return chute, and a voucher/refund dispenser.

5. A system for dispensing and collecting reusable bags at a store, substantially as shown and described.

6. A method of dispensing and collecting reusable bags at a store, substantially as shown and described.
